(19) United States
(12) Patent Application Publication
(10) Pub. No.: US 2021/0084366 A1
(43) Pub. Date: Mar. 18, 2021

(54) ELECTRONIC DEVICE, CONTROL METHOD THEREFOR, AND COMPUTER-READABLE RECORDING MEDIUM

(71) Applicant: SAMSUNG ELECTRONICS CO., LTD., Suwon-si, Gyeonggi-do (KR)

(72) Inventors: Sang-un YUN, Seoul (KR); Yong-woo SHIN, Seoul (KR); Ha-yeon KIL, Seoul (KR)

(73) Assignee: SAMSUNG ELECTRONICS CO., LTD., Suwon-si, Gyeonggi-do (KR)

(21) Appl. No.: 16/959,601

(22) PCT Filed: Jul. 27, 2018
(86) PCT No.: PCT/KR2018/008566

§ 371 Date: Jul. 1, 2020

(30) Foreign Application Priority Data
Jan. 16, 2018 (KR) 10-2018-0005689

(51) Int. Cl. H04N 21/4415; H04N 21/436; H04N 21/443; H04N 21/45; H04N 21/431

(52) U.S. Cl. CPC H04N 21/4415; H04N 21/436; H04N 21/431; H04N 21/4532; H04N 21/4438

(57) ABSTRACT

An electronic device is disclosed. An electronic device of the present disclosure comprises a memory, a display, and a processor for: when a user is identified while the display is operating in a standby mode that is a deactivated state, preloading at least one content providing source on the basis of a use history of the identified user, which is stored in the memory; and when a control command for switching the mode of the electronic device to a content reproduction mode is input, activating the display, and controlling the display to display a screen of a content providing source corresponding to the control command from among the at least one content providing source.

### TECHNICAL FIELD

This disclosure relates to an electronic device, a control method therefor, and a computer-readable recording medium and, more particularly, to an electronic device enabling quick booting by preloading a content providing source based on a use history, a control method therefor, and a computer-readable recording medium.

### BACKGROUND ART

Development in an electronic device has led to development and distribution of various types of electronic products. Various electronic devices such as a television (TV), a mobile phone, a personal computer (PC), a notebook PC, a personal digital assistant (PDA), a set-top box, or the like, are widely used in general households.

Increase in the use of electronic devices has increased the needs for more diverse functions. As a result, the efforts of each manufacturer to meet the user's needs are also increased, so that products having new functions that have not been previously present are emerging.

Recently, an external device such as a set-top box, a blu-ray disc, an audio device, a mobile device, a PC, or the like, is connected to a display device for use. In this case, if a user desires to use the contents provided from the external device, it is inconvenient to perform the procedure as shown in FIG. 1.

Specifically, referring to FIG. 1, in a related art, in a state where an electronic device is turned off, when a power-on command is input, the electronic device is booted to a screen of a last-watched channel or a last-used input source. Then, a user may watch a desired content only after selecting an input source to be used and selecting a desired content among a plurality of contents provided by the selected input source. This is a complicated and repetitive manipulation procedure to a user, and there is a problem in that a lot of time is required until reproducing a desired content.

There is a necessity to develop technology to reproduce a content desired by a user simultaneously with turning on a screen of an electronic device.

### DISCLOSURE

### Technical Problem

The disclosure is to address the above-described problems, and an object of the disclosure is to provide an electronic device enabling quick booting by preloading a content providing source based on a use history, a control method therefor, and a and a computer-readable recording medium.

### Technical Solution

According to an embodiment, an electronic device includes a memory, a display, and a processor configured to, based on a user being identified while the display is operating in a standby mode that is a deactivated state, preload at least one content providing source based on a use history of the identified user, which is stored in the memory, and based on a control command for switching a mode of the electronic device to a content reproduction mode being input, activate the display, and control the display to display a screen of a content providing source corresponding to the control command from among the at least one content providing source.

The electronic device may further include a communicator configured to communicate with an external device, and the processor may, based on a content providing source provided by the external device being included in the at least one content providing source, receive, from the external device, information on the content providing source through the communicator, and preload the content providing source provided from the external device based on the received information.

The processor may preload different content providing sources according to a time at which the user is identified.

The processor may, based on the user not being identified, preload at least one content providing source based on use history of a plurality of users stored in the memory.

The electronic device may further include a communicator configured to communicate with an external device, and the processor may, based on receiving, from the external device, information on the content providing source provided by the external device through the communicator during operation in a standby mode, preload the content providing source provided by the external device based on the received information, and based on receiving, from the external device, an activation command of the display according to a power-on command associated with the external device, control the display to display a screen of the content providing source provided by the external device.

The processor may identify the user based on at least one of an input fingerprint, an input voice print, and an input identification (ID) of a smartphone.

The control command may include an execution command of one content providing source among the at least one content providing source.

The processor may identify the at least one content providing source to be preloaded using an artificial intelligence (AI) technology.

The processor may change setting of the electronic device based on content provided from a content providing source corresponding to the control command.

The electronic device of may further include a communicator configured to communicate with an Internet of Things (IoT) device, and the processor may control the communicator to transmit, to the IoT device, a control command to control the IoT device based on content provided from a content providing source corresponding to the control command.

According to an embodiment, a method for controlling an electronic device includes, based on a user being identified while the display is operating in a standby mode that is a deactivated state, preloading at least one content providing source based on a use history of the identified user, and based on a control command for switching a mode of the electronic device to a content reproduction mode being input, activating the display, and displaying a screen of a content providing source corresponding to the control command from among the at least one content providing source.

The preloading may include, based on a content providing source provided by the external device being included in the at least one content providing source, receiving, from the external device, information on the content providing source, and preloading the content providing source provided from the external device based on the received information.

The preloading may include preloading different content providing sources according to a time at which the user is identified.

The preloading may include, based on the user not being identified, preloading at least one content providing source based on presorted use history of a plurality of users.

The preloading may include, based on receiving, from the external device, information on the content providing source provided by the external device during operation in a standby mode, preloading a content providing source provided by the external device based on the received information, and based on receiving, from the external device, an activation command of the display according to a power-on command associated with the external device, displaying a screen of the content providing source provided by the external device.

The method may further include identifying the user based on at least one of an input fingerprint, an input voice print, and an input identification (ID) of a smartphone.

The preloading may include identifying the at least one content providing source to be preloaded using an artificial intelligence (AI) technology and preloading the identified at least one content providing source.

The method may further include changing setting of the electronic device based on content provided from a content providing source corresponding to the control command.

The method may further include transmitting, to the IoT device, a control command to control the IoT device based on content provided from a content providing source corresponding to the control command.

A computer-readable recording medium including a program to execute a control method of an electronic device according to an embodiment includes the control method including, based on a user being identified while the display is operating in a standby mode that is a deactivated state, preloading at least one content providing source based on a use history of the identified user and based on a control command for switching a mode of the electronic device to a content reproduction mode being input, activating the display, and displaying a screen of a content providing source corresponding to the control command from among the at least one content providing source.

### DESCRIPTION OF DRAWINGS

FIG. 1A is a diagram illustrating a content reproduction process according to a related art;

FIG. 2 is a diagram illustrating a content providing system according to an embodiment;

FIG. 3 is a block diagram illustrating a brief configuration of an electronic device according to an embodiment;

FIG. 4 is a block diagram illustrating a detailed configuration of the electronic device of FIG. 3;

FIG. 5 is a diagram illustrating a content reproduction process according to an embodiment;

FIGS. 6-8 are diagrams illustrating a content reproduction process according to various embodiments of a user identification method;

FIG. 9 is a diagram illustrating content reproduction of the electronic device according to another embodiment;

FIG. 10 is a diagram illustrating an embodiment of setting an environment according to a reproduced content;

FIG. 11 is a flowchart describing a content reproduction method according to an embodiment;

FIG. 12 is a sequence diagram illustrating a method for reproducing a content of a content providing source provided from an external device; and

FIG. 13 is a sequence diagram illustrating a method for reproducing a content through control of the external device illustrated in FIG. 9.

### DETAILED DESCRIPTION OF EXEMPLARY EMBODIMENTS

Before specifically describing the disclosure, a method for demonstrating the present specification and drawings will be described.

Terms used in the present specification and the claims are general terms identified in consideration of the functions of the various embodiments of the disclosure. However, these terms may vary depending on intention, legal or technical interpretation, emergence of new technologies, and the like of those skilled in the related art. Also, there may be some terms arbitrarily identified by an applicant. Unless there is a specific definition of a term, the term may be construed based on the overall contents and technological common sense of those skilled in the related art.

These embodiments are capable of various modifications and have various embodiments, and specific embodiments are illustrated in the drawings and described in detail in the description. It should be understood, however, that it is not intended to limit the scope of the specific embodiments but includes all transformations, equivalents, and alternatives falling within the disclosed spirit and scope. When it is decided that a detailed description for the known art related to the disclosure may unnecessarily obscure the gist of the disclosure, the detailed description will be omitted.

The terms such as “first,” “second,” and so on may be used to describe a variety of elements, but the elements should not be limited by these terms. The terms are used only for the purpose of distinguishing one element from another.

A singular expression includes a plural expression, unless otherwise specified. It is to be understood that the terms such as “comprise” or “consist of” are used herein to designate a presence of a characteristic, number, step, operation, element, component, or a combination thereof, and not to preclude a presence or a possibility of adding one or more of other characteristics, numbers, steps, operations, elements, components or a combination thereof.

The term such as “module,” “unit,” “part”, and so on is used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor.

Hereinafter, non-limiting example embodiments of the disclosure will be described in detail with reference to the accompanying drawings so that those skilled in the art to which the disclosure pertains may easily practice the disclosure. However, the disclosure may be implemented in various different forms and is not limited to embodiments described herein. In addition, in the drawings, portions unrelated to the description will be omitted, and similar portions will be denoted by similar reference numerals throughout the specification.

Hereinafter, embodiments will be described in detail with reference to the accompanying drawings.

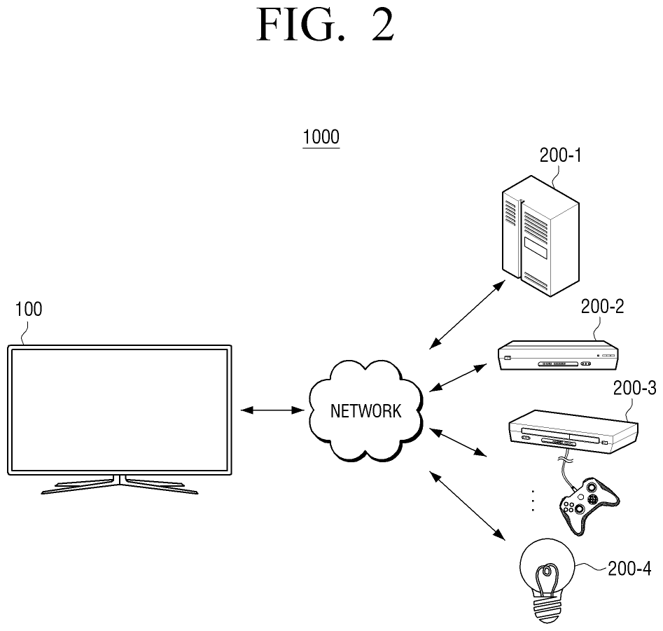

FIG. 2 is a diagram illustrating a content providing system according to an embodiment.

Referring to FIG. 2, a content providing system 1000 includes an electronic device 100 and a plurality of external devices 200-1 to 200-4 connected to the electronic device 100 via network.

The electronic device 100 may receive and process content from the external devices 200-1 to 200-4. The electronic device 100 may be a variety of devices having a display, such as a TV, a cellular phone, a smartphone, a personal digital assistant (PDA), a notebook personal computer (PC), a monitor, a tablet PC, an electronic book, an electronic frame, a kiosk, or the like. The electronic device 100 may display a processed content. The electronic device 100 may be a variety of devices that do not have a display, such as a server, a set-top box, or the like. In this example, the electronic device 100 may transmit the processed content to another device having a display.

Although not illustrated in FIG. 2, the electronic device 100 includes a control box that is present separately from the electronic device 100 and is connected to the electronic device 100 via an optical cable. The control box may control the electronic device to display various screens, and may perform overall operations of the electronic device. For example, the control box may analyze a screen corresponding to an image signal received from the external device and transmit the screen to the electronic device 100. The control box may generate a control command corresponding to the command input from the user through the electronic device 100, and transmit the generated control command to the external device. As such, as a separate control box exists, it is possible to connect the peripheral devices to the control box and conveniently connect the control box to the electronic device 100 with a single line without connecting all the peripheral devices complicatedly to the electronic device 100. Therefore, user's convenience can be improved. The control box may be referred to as a one connect (OC) box, an invisible box, or the like, based on the function described above.

The external devices 200-1 through 200-4 may be devices that transmit content to the electronic device 100. The external devices 200-1 to 200-4 may include a broadcasting station server 200-1, a set-top box 200-2, a game console 200-3, and an Internet of Things (IoT) device 200-4. Although not illustrated, the external device may further include an external memory device other than the above-described device, a Bluetooth disk, a PC, a mobile device such as a smartphone, or the like. In FIG. 2, a lighting is illustrated as the IoT device 200-4 which can be controlled by the electronic device 100, but various devices such as a refrigerator, a washing machine, an outlet, and a door lock, or the like, may be included. The electronic device 100 and the external devices 200-1 to 200-4 may be connected in a wired manner, such as a high definition multimedia interface (HDMI), or may be connected in a wireless manner such as Wi-Fi, Bluetooth, or the like.

The electronic device 100 may recognize the connected external devices 200-1 to 200-4, construct the devices as a database (DB), and store the DB. Specifically, the electronic device 100 may recognize a manufacturer of the connected external devices 200-1 to 200-4, a product name of the external devices 200-1 to 200-4, an application and a content stored in the external devices 200-1 to 200-4, and build them as database.

The database may be constructed in a variety of ways, for example, a user may immediately input information about external devices 200-1 through 200-4 to the electronic device 100. According to still other embodiments, the electronic device 100 may automatically recognize information about the external devices 200-1 to 200-4. For example, electronic device 100 may obtain information for the external devices 200-1 to 200-4 in an image signal provided from the external devices 200-1 to 200-4. For example, the electronic device 100 may extract a logo, a business name, an application, or the like, from a screen corresponding to an image signal provided by the external devices 200-1 to 200-4 to obtain information on the external devices 200-1 to 200-4.

The electronic device 100 may identify the user in a variety of ways and may preload the at least one content providing source based on the pre-stored use history of the electronic device 100. Specifically, a plurality of content providing sources frequently used by a user may be executed in advance, and the content desired by a user or the screen of the content providing source may be displayed immediately at the same time as the display of the electronic device 100 is turned on.

The content providing source may refer to a program for providing content to the electronic device 100, and may mean an application installed in the electronic device 100, an application installed in the external devices 200-1 to 200-4, or the like. The preloading is an operation to receive data for displaying a screen of the application in advance, and generate a screen in advance using the received data to generate a content or a screen of the content or content providing source before the display of the electronic device 100 is activated.

For example, if the electronic device 100 identifies a user that is a movie and a drama maniac, preloads a home screen of an application that provides a screen and a movie of the most frequently viewed channel among the TV channels based on the identified user's use history, and inputs a control command to reproduce “AA movie,” a display may be activated, and a home screen of the preloaded movie application may be displayed immediately. If the user frequently reproduces the “AA movie,” the electronic device 100 may preload a start screen of the “AA movie” based on viewing history, and if the user inputs a control command to reproduce the “AA movie,”, the electronic device 100 may activate the display and reproduce the “AA movie” immediately.

At the same time as the display is turned on according to input of a command to activate the electronic device 100, a screen of a content desired by the user may be displayed immediately. According to an embodiment, after the display is turned on, a content screen may be displayed immediately without booting.

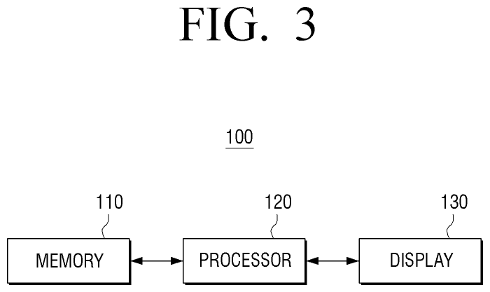

FIG. 3 is a block diagram illustrating a brief configuration of an electronic device according to an embodiment.

Referring to FIG. 3, the electronic device 100 may include a memory 110, a processor 120, and a display 130.

The memory 110 may store various programs and data necessary for operating the electronic device 100. The memory 110 may store information on an application providable by the electronic device 100 and use history of the electronic device 100.

The memory 110 may store not only the installation information of the application, but also the content that can be provided in the application. The use history may include various information such as the name of the content viewed by the user, the viewing time, the number of times, genre information, or the like.

User identification information may be stored in the memory 110. The memory 110 may be stored with at least one fingerprint information or voice print information of the user using the electronic device 100 to identify a user using the electronic device 100. In addition to user-specific information, such as fingerprint information or voice print information, the memory 110 may store information about the user's smartphone identification (ID). The above-described fingerprint information, voice print information, and smartphone ID information may be previously input by the user.

The processor 120 may control the overall operation and functionality of the electronic device 100. Although not shown, the processor 120 may include a microcomputer that controls the activated configuration in a standby mode in which only a portion of the electronic device 100 is activated. In the standby mode, a microcomputer, a communicator (not shown) for transmitting and receiving data to and from an external device, the memory 110, or the like, may be activated, and the display 130 may be deactivated.

The display 130 may display a screen corresponding to an image signal by the control of the processor 120. The display 130 may display content by the control of the processor 120 or may display a user interface (UI) to provide a user with information or a UI for receiving user's confirmation.

The display 130 may be implemented in various forms such as a liquid crystal display (LCD), an organic light emitting diode (OLED) display, a plasma display panel (PDP), or the like. In the display 130, a backlight unit, a driving circuit which may be implemented as an a-si TFT, low temperature poly silicon (LTPS) TFT, organic TFT (OTFT), or the like, may be included as well.

It has been described that the display function and gesture detection function are performed by the same configuration, but the functions may be performed by different configurations. According to various embodiments, the display 130 may not be provided in the electronic device 100.

The processor 120 may preload at least one content providing source based on the user's use history if the user is identified while the display 130 is operating in a standby mode in a deactivated state. Identifying a user may mean that a user who wishes to use the electronic device 100 is identified.

The processor 120 may identify a user based on at least one of the fingerprint, voice print, ID of the smartphone input to the electronic device 100. The database associated with a fingerprint, a voice print, and ID of a smartphone of a plurality of users may be stored in the memory 110.

Once the user has been identified, the processor 120 may preload the at least one content providing source based on the use history by the identified user using the electronic device 100. At this time, the use history of the user may be stored in the memory 110. The preloaded content providing source may be at least one of an application installed in the electronic device 100, content, an application provided by an external device, or content.

The processor 120 may identify an input source that the user has frequently used based on use history, an application running on the input source, content, and the like. The processor 120 may identify the content providing source in consideration of the time when the user executes the application or the content. That is, if the time at which the user is identified is different, the other content providing source may be preloaded.

For example, the processor 120 may identify at least one content providing source which is greater than or equal to a predetermined value according to each preference of the plurality of content providing sources and preload. The processor 120 may identify a predetermined number of content providing sources in a descending order of preference and preload.

At this time, if an application or content frequently used by a user is stored in the electronic device 100, the processor 120 may preload an application or a screen of the content while the display 130 is deactivated. Alternatively, if an application or content frequently used by a user is stored in an external device, the processor 120 may connect the display 130 to an external device in a state where the display 130 is deactivated, receive information of the application or content from an external device, and preload the screen using the received information.

The preloading operation of the processor 120 may be implemented as an artificial intelligence (AI) system utilizing machine learning algorithm and an application thereof. The processor 120 may learn preferred content providing sources by users and identify a content providing source to be preloaded.

The artificial intelligence (AI) system is a computer system for implementing the intelligence of a human level, and is a system in which a machine is self-learning, and the recognition rate is improved when used. The AI technology is composed of machine learning (deep learning) technique using an algorithm for classifying/learning characteristics of input data by itself and elementary technologies for simulating functions such as recognition, judgment, and the like of a human brain using a machine learning algorithm.

The elementary technologies may include, for example, at least one of a linguistic understanding technique for recognizing a human language/character, a visual understanding technique for recognizing an object as a human visual, an inference/prediction technique for determining and logically inferring and predicting information, a knowledge representation technology for processing human experience information as knowledge data, and an operation control technique for controlling the autonomous driving of the vehicle, the motion of the robot, or the like.

With respect to image recognition technique, visual understanding is a technique for recognizing and processing objects as human vision, including object recognition, object tracking, image search, human recognition, scene understanding, spatial understanding, image enhancement, and the like.

With respect to information recommendation technique, inference prediction is a technique for judging and logically inferring and predicting information, including knowledge-based and probability-based inference, optimization prediction, preference-based planning, recommendation, or the like.

With respect to query processing technique, knowledge representation is a technique for automating human experience information into knowledge data, including knowledge building (data generation or classification), knowledge management (data utilization), or the like.

If the user inputs a control command to switch the mode of the electronic device 100 from the standby mode to the content reproduction mode, the processor 120 may control the display 130 to display a screen of the content providing source corresponding to the control command among the preloaded at least content providing sources.

Specifically, a control command to switch the mode of the electronic device 100 to the content reproduction mode may include a control command to activate the display 130. For example, when the display 130 is deactivated to show as if the electronic device 100 is powered off, when the user inputs a power-on command or presses any button of the connected remote controller, the processor 120 may identify that a control command for switching the mode of the electronic device 100 to the content reproduction mode is input. In this example, the remote controller may be a remote controller dedicated to the electronic device 100 or a smartphone capable of controlling the electronic device 100.

A control command to switch the mode of the electronic device 100 to the content reproduction mode may include an execution command of the content providing source. The execution command of the content providing source may include a control command to change the mode of the electronic device 100 for execution. The content providing source, which is the subject of the execution command, may be one of the preloaded content providing sources.

When it has been detected that there is a user desiring to use the electronic device 100, but it is not identifiable who is the user, the processor 120 may preload at least one content providing source based on the use history of the plurality of users stored in the memory 110. Specifically, a content providing source preferred for each of a plurality of users may be preloaded.

The processor 120 may change the setting of the electronic device 100 based on the content provided by the content providing source corresponding to the control command. Specifically, the processor 120 may change the settings of the electronic device 100 according to the content being executed by the user's control command of the at least one content providing source that is preloaded based on the user's use history.

For example, if the content corresponding to the user's execution command is a movie, the setting of the image quality and sound quality of the electronic device 100 may be adjusted to be suitable for reproducing the movie. Table 1 below illustrates an example of the configuration of the electronic device 100 according to a type of content for convenience.

TABLE 1

| | Image quality | Sound Quality |
|---|---|---|
| Movie | Movie mode | Optimized mode (Movie) |
| Sports | Dynamic mode | Amplified mode (Game) |
| News | Standard mode | Optimized mode (News) |
| Game | Game mode | Amplified mode (Game) |
| Others | Normal mode | Standard mode |

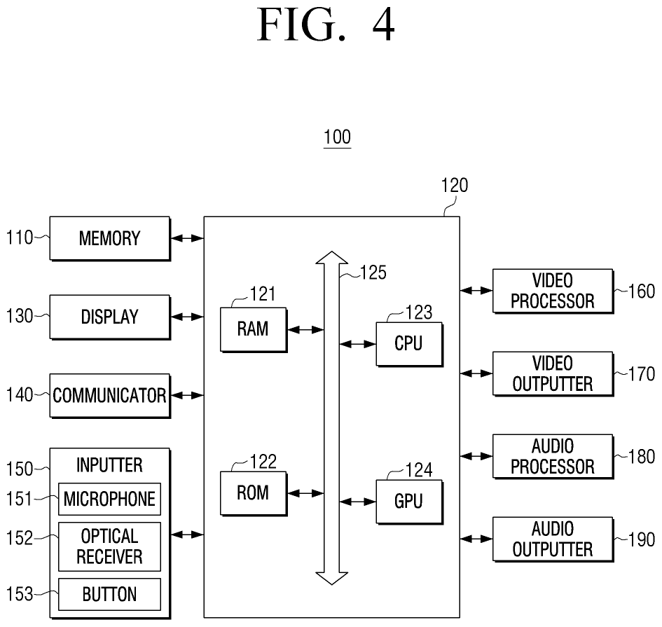

The processor 120 may change a setting of an external device connected to the electronic device 100 based on content provided by a content providing source corresponding to a control command. This will be described in greater detail with reference to FIG. 4 illustrating a communicator.

As described above, by preloading the content providing source preferred by a user, a content may be displayed immediately without booting when a user inputs an execution command. Accordingly, the user may enjoy improved use experience.

FIG. 4 is a block diagram illustrating a detailed configuration of the electronic device of FIG. 3.

Referring to FIG. 4, the electronic device 100 may include a memory 110, a processor 120, a display 130, a communicator 140, an inputter 150, a video processor 160, an audio processor 180, and an audio outputter 190.

The memory 110 and the display 130 have the same configurations as FIG. 3 and thus will not be further described.

The processor 120 may include random access memory (RAM) 121, read only memory (ROM) 122, a central processing unit (CPU) 123, a graphic processing unit (GPU) 124, and a bus 125. The RAM 121, ROM 122, CPU 123, GPU 124, or the like, may be interconnected through the bus 125.

The CPU 123 accesses the memory 110 and performs booting using an operating system (OS) stored in the memory 110. The CPU 123 may perform various operations using various programs, contents, data stored in the memory 110, and the like.

The ROM 122 stores a command set for booting the system. When a turn-on command is input and power is supplied, the CPU 123 copies the OS stored in the memory 110 to the RAM 121 according to the command stored in the ROM 122, executes the OS, and boots the system. When the booting is completed, the CPU 123 copies various programs and/or instructions stored in the memory 110 to the RAM 121, executes the program(s) and/or instruction(s) copied to the RAM 121, and performs various operations.

When booting of the electronic device 100 is completed, the GPU 124 displays a user interface (UI) on the display 130. The GPU 124 may generate a screen including various objects such as an icon, an image, and a text using a calculator (not shown) and a renderer (not shown). A calculator may calculate an attribute value such as a coordinate value, a shape, a size, and a color to be displayed by each object according to the layout of the screen based on the received control command. A renderer may generate display screens of various layouts including objects based on the attribute value calculated by the calculator. The screen (or a user interface window) generated by the renderer may be provided to the display 130 and displayed on a main display area and a sub-display area respectively.

It has been described that the processor 120 includes one central processing unit 123 only, but in implementation, the processor 120 may be implemented as a plurality of CPUs (or a digital signal processor (DSP), system on chip (SoC), or the like).

The communicator 140 is configured to communicate with an external device. The communicator 140 may receive an image signal or a control command from an external device. The communicator 140 may transmit a control command generated by the processor 120 to an external device.

The communicator 140 may communicate with an external device in a wired or a wireless manner.

The communicator 140 may be connected to an external device in a wireless manner, such as a wireless LAN, a Bluetooth, or the like. The communicator 140 may be connected to an external device using Wi-Fi, Zigbee, or infrared data association (IrDA). The communicator 140 may include a wired connection port. The communicator 140 may include a wired Ethernet, a high definition multimedia interface (HDMI) port, a component port, a PC access port, a universal serial bus (USB) port, or the like. The communicator 140 may include a digital visual interface (DVI), a red green blue (RGB) color, a D-subminiature (D SUB), a super video (S-Video), or the like.

The communicator 140 may receive information about a content providing source from an external device under the control of the processor 120. Specifically, if the content providing source preferred by the user includes the content providing source provided from the external device based on the identified user's use history, the processor 120 may receive information about the content providing source from the external device via the communicator 140 and preload the content providing source using the received information.

The communicator 140 may receive the display 130 activation command from an external device under the control of the processor 120. When the information on the content providing source provided by the external device is received through the communicator 140 while the electronic device 100 is operating in the standby mode, the processor 120 may preload the content providing source based on the received information.

For example, while the electronic device 100 is operating in a standby mode, if the user moves or operates the remote controller of the external device, the external device may transmit information about the content providing source to the electronic device 100. The information on the content providing source transmitted to the electronic device 100 may be the information identified by the external device based on the user history stored in the external device. As another embodiment, if the external device detects that the user performs a preparation operation for external device control, the external device may transmit the sensed information to the electronic device 100, and the electronic device 100 may request information about the content providing source to the external device based on the use history.

If the user inputs a command for executing the content providing source provided from the external device to the external device, the electronic device 100 may receive the activation command of the display 130 from the external device via the communicator 140. The processor 120 may activate the display 130 and display a screen of a content providing source provided by the external device immediately.

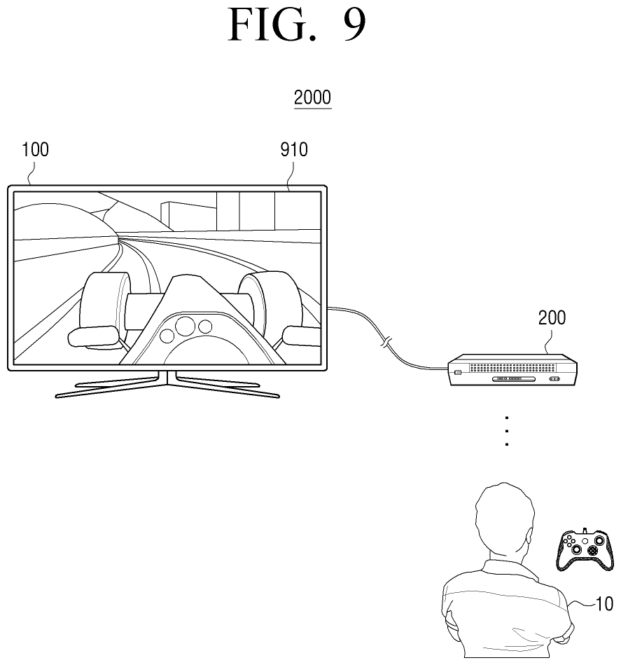

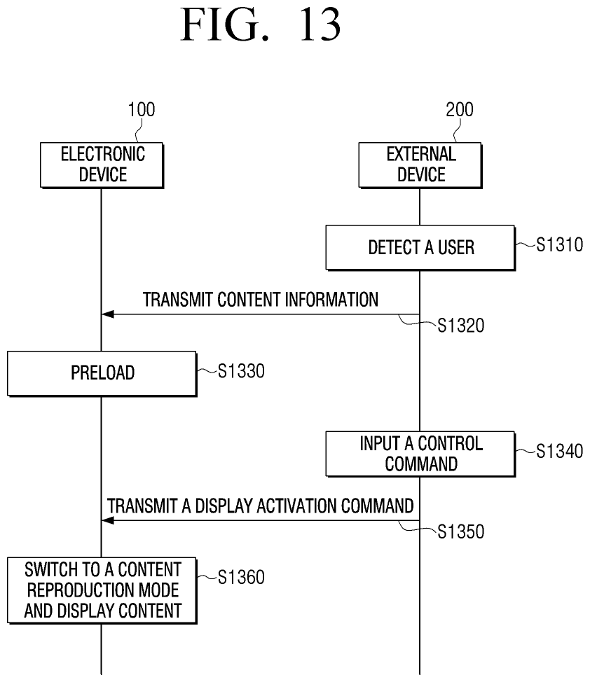

When the electronic device 100 is in the standby mode, even when the user controls the external device connected to the electronic device 100 without controlling the electronic device 100, the processor 120 may display the content provided by the external device immediately after activating the display 130. This will be described in detail with reference to FIGS. 9 and 13.

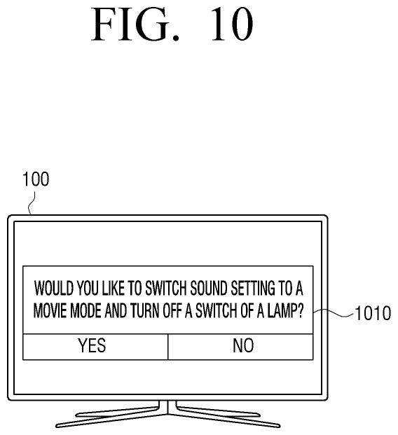

The communicator 140 may communicate with an Internet of Things (IoT) device. The communicator 140 may communicate with the IoT device such as a lamp, a refrigerator, a washing machine, a door lock, or the like, which may be controlled through the electronic device 100. The processor 120 may transmit a control command for controlling the IoT device to the IoT device via the communicator 140. The processor 120 may transmit a control command to control the IoT device based on a content executed by a control command to the IoT device via the communicator 140. For example, if the content to be executed by the control command is a movie, the processor 120 may transmit a control command to turn off a switch to a lamp which is one of the IoT device connected to the electronic device 100, or transmit a control command to change to the noise reduction mode of the peripheral IoT device. The processor 120 may immediately transmit a control command of the IoT device to the IoT device in accordance with the executed contents, but in another embodiment, as shown in FIG. 10, the processor 120 may display, on the display 130, a user interface (UI) screen for receiving the user's confirmation on the IoT device before transmitting the control command of the IoT device.

By adequately controlling a peripheral environment according to the executed content, a user's convenience may be improved.

The inputter 150 is configured to receive a user's interaction such as user's voice, user's operation, or the like.

The inputter 150 may include a microphone 151 for receiving a user's voice, an optical receiver 152 for receiving an optical signal corresponding to a user input (e.g., a touch, a press, a touch gesture, a voice, or a motion) from a remote controller, and a button 153 formed in an arbitrary region such as a front portion or a side portion, a rear portion, or the like of an exterior of a main body of the electronic device 100.

The button 153 may be various types of buttons such as a mechanical button, a touch pad, a wheel, or the like. The button 153 may be configured to receive voice data and fingerprint data of a user. For example, the user may input voice to the electronic device 100 by pressing a button for voice input, and if there is a fingerprint recognition function on the surface of the button 153, the electronic device 100 may also receive a user's fingerprint as well. The button 153 may be provided in the electronic device 100, or may be provided in a remote controller communicating with the electronic device 100.

Though not illustrated, according to an embodiment, the inputter 150 may further include a camera capturing a user image to detect existence of a user in front of the electronic device 100 and recognize a user's face, a touch screen for receiving a user touch, or a sensor capable of detecting a user's motion.

A video processor 160 is configured to process content received through the communicator 140 or video data included in the content stored in the memory 110. The video processor 160 may perform various image processing such as decoding, scaling, noise filtering, frame rate conversion, resolution conversion, or the like, for the video data.

The video outputter 170 may output the processed video data from the video processor 160. If the display 130 is provided in the electronic device 100, the video outputter 170 may be the same configuration as the display 130, but in a case where the display 130 is not included in the electronic device 100 or an image is to be displayed on an external display device, the video outputter 170 may be in a form of a port that provides an image signal to the external display device.

The audio processor 180 is a component for processing content received through the communicator 140 or audio data included in the content stored in the memory 110. The audio processor 180 may perform various processes such as decoding, amplification, noise filtering, etc. on the audio data.

When a reproduction application for multimedia contents is executed, the processor 120 may drive the video processor 160 and the audio processor 180 to reproduce the corresponding contents. The display 130 may display the image frame generated by the video processor 160 in at least one of a main display area and a sub display area.

The audio outputter 190 outputs audio data generated by the audio processor 180. The audio outputter 190 is configured to convert and output a voice signal to a sound as a speaker provided in the electronic device 100 or in a port format providing a voice signal to an external speaker.

It has been described as if the video outputter 170 and the audio outputter 190 are separate configurations, but if the electronic device 100 includes an HDMI port, or the like, for simultaneously transmitting a video signal and an audio signal, the video outputter 170 and the audio outputter 190 may be implemented physically as one configuration.

When an image is transmitted to an external display device through the video outputter 170, the processor 120 may add a graphic user interface (GUI) to a transmitted image and transmitted the image. The processor 120 may transmit the image in which the GUI is added to the image output from the video processor 160 to an external display device.

Although not illustrated in FIG. 4, in some embodiments, a USB port to which a USB connector may be connected, an HDMI port, a headset, a mouse, various externa input ports for connecting to various external devices such as LAN, a digital multimedia broadcasting (DMB) chip for receiving and processing a DMB signal, various sensors, or the like may be further included.

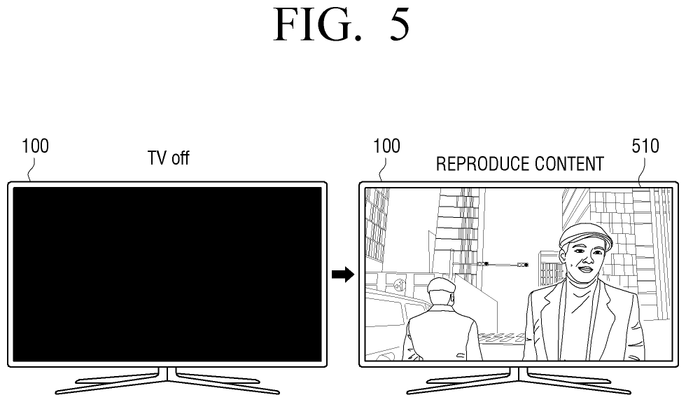

FIG. 5 is a diagram illustrating a content reproduction process according to an embodiment.

Referring to FIG. 5, in a standby mode in which a display is deactivated, the electronic device 100, based on receiving a control command to convert to a content reproduction mode, may activate the display and immediately display a content 510 corresponding to the control command.

When a user is identified, the electronic device 100 may preload at least one content providing source based on prestored use history of the user.

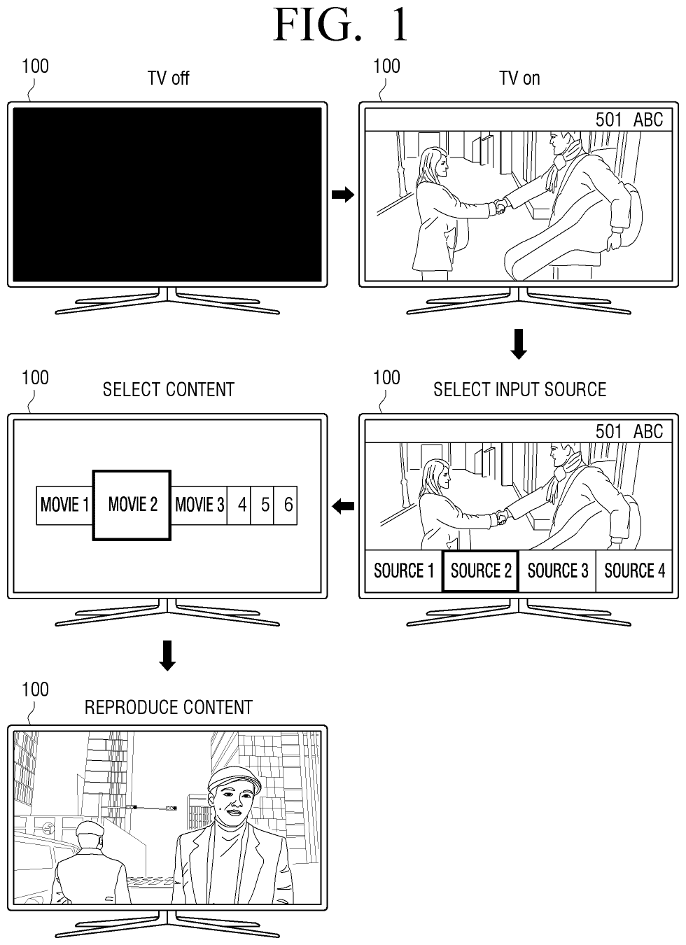

When compared to a related art illustrated in FIG. 1, an input source may be selected after a display is activated according to a user's control command and a desired content is immediately displayed without a process of selecting an application or a content, and a booting process according to an application execution command is omitted and thus, a user's use environment may be improved.

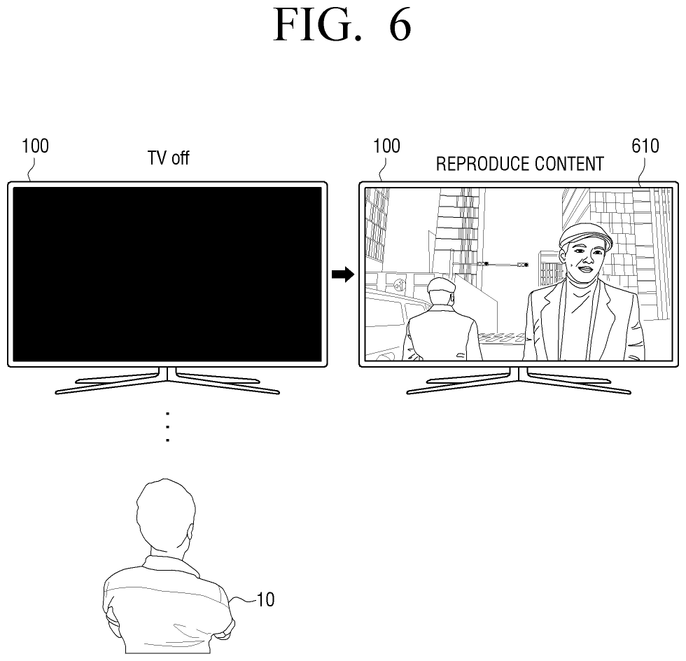

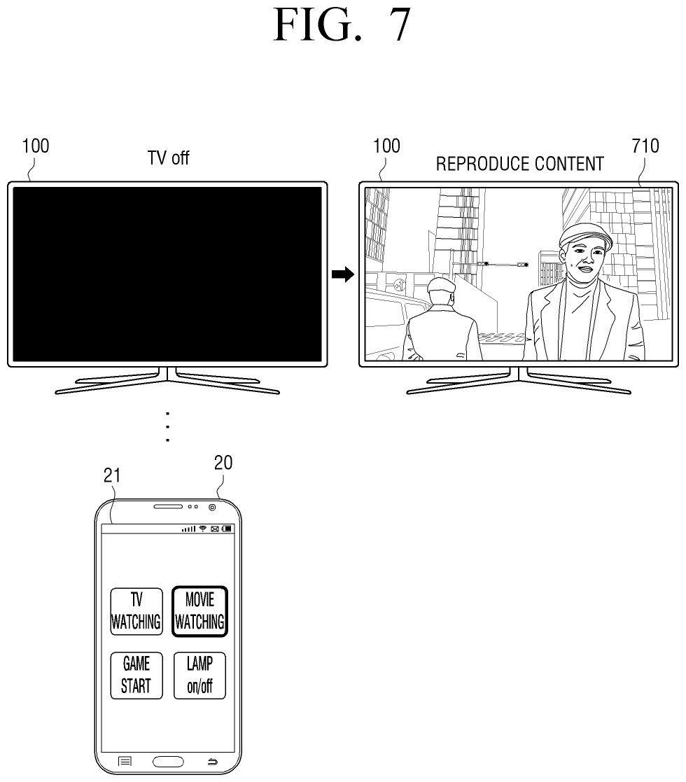

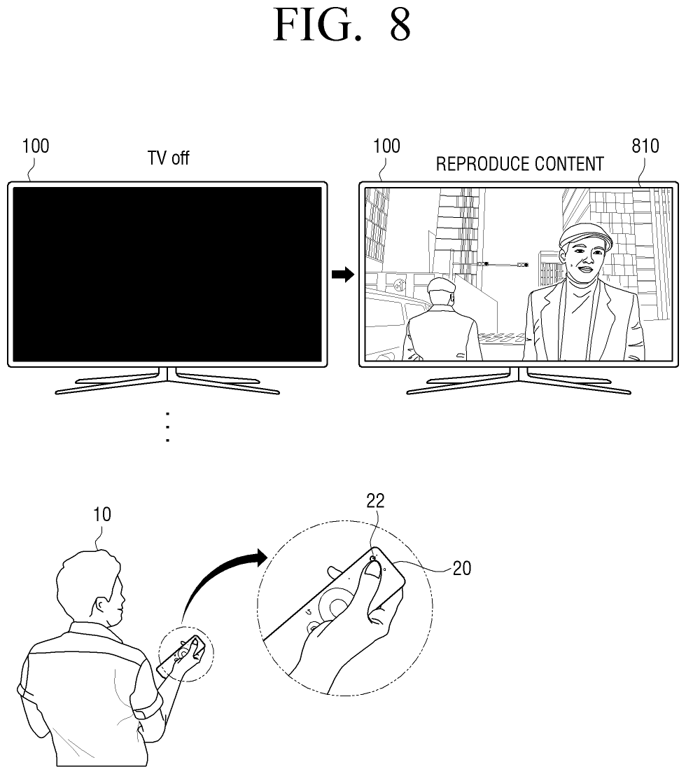

FIGS. 6-8 are diagrams illustrating a content reproduction process according to various embodiments of a user identification method. To be specific, FIG. 6 illustrates an embodiment of identifying a user by a voice print according to a user's voice command input; FIG. 7 illustrates an embodiment of identifying a user by using a smartphone ID; and FIG. 8 illustrates an embodiment of identifying a user by using finger print recognition.

Referring to FIG. 6, a user may utter a trigger voice for voice control of the electronic device 100. The electronic device 100 may compare the stored voice print of a plurality of users with the voice print of the trigger voice uttered by the user to identify the most similar user. Even when a user inputs a content execution command rather than a trigger voice by a voice, some or all of the inputted commands may be used to identify the user.

The electronic device 100 may preload at least one content providing source preferred by the identified user using the identified use history of a user.

If the user inputs a control command to switch the mode of the electronic device 100 from the standby mode to the content reproduction mode, the electronic device 100 may switch the display from the deactivated state to the activated state, and may immediately display the content corresponding to the control command. When the user inputs the execution command of the content providing source by voice, the electronic device 100 may activate the display of the deactivated state and immediately displays the screen 610 of the content providing source corresponding to the execution command among the preloaded at least one content providing sources.

Referring to FIG. 7, a user may execute a remote control application 21 of the electronic device 100 to control the electronic device 100 by a smartphone 20. The electronic device 100 may identify the user by comparing the ID of the smartphone with the ID of the smartphone corresponding to the plurality of stored users, respectively. Even if the user's smartphone 20 is connected to the electronic device 100 without executing the remote control application, the electronic device 100 may identify the user using the ID of the connected smartphone 20.

The electronic device 100 may preload at least one content providing source preferred by the identified user using use history of the identified user.

If the user inputs a control command to switch the mode of the electronic device 100 from the standby mode to the content reproduction mode, the electronic device 100 may switch the display from the deactivated state to the activated state, and may immediately display the content corresponding to the control command. When the remote control application 21 of the smartphone 20 is executed, if desired content is selected in the control UI displayed on the smartphone, the electronic device 100 may activate the display of the deactivated state and immediately display a screen 710 of the content providing source corresponding to the selection of the preloaded content providing source.

Referring to FIG. 8, the user may perform an operation to control the electronic device 100 by the remote controller 20. Specifically, the user may hold the remote controller 20 to turn on the electronic device 100 and press a power button 22. In this example, a fingerprint recognition function may be provided to the power button 22 of the remote controller 20.

The fingerprint information recognized as the user moves the remote controller 20 and touches a finger on the power button 22 may be transmitted to the electronic device 100, and the electronic device 100 may compare fingerprint information of the user received from the remote controller 20 and the stored fingerprint information of a plurality of users to identify the user.

In FIG. 8, the remote controller 20 is illustrated as being a remote controller, but in actual implementation, the remote controller 20 may be a smartphone as in FIG. 7, and may identify a user using a fingerprint recognition function of a smartphone.

The electronic device 100 may preload at least one content providing source preferred by the identified user using use history of the identified user.

If the user inputs a control command to switch the mode of the electronic device 100 from the standby mode to the content reproduction mode, the electronic device 100 may switch the display from the deactivated state to the activated state, and may immediately display the content corresponding to the control command. If the user inputs the execution command of the content providing source by voice, the electronic device 100 may activate the display of the deactivated state and immediately display a screen 810 of the content providing source corresponding to the execution command among the preloaded content providing sources.

FIG. 9 is a diagram illustrating content reproduction of the electronic device according to another embodiment. It is described an embodiment that the content providing system 2000 controls the external device 200 instead of the electronic device 100.

Referring to FIG. 9, when the user 10 controls the external device 200 while the electronic device 100 is in the standby mode, the electronic device 100 may display a screen 910 provided by the external device 200 immediately after activating the display. FIG. 9 illustrates a game console as an example of an external device 200.

Specifically, if the user 10 moves the remote controller of the game console which is the external device 200, in a standby mode where the display of the electronic device 100 is deactivated, the electronic device 100 may preload the home screen or content provided by the external device 200. The electronic device 100 may preload at least one screen based on the history of use of the external device 200 of the user 10, and the operation of identifying the preloaded screen may be performed by the electronic device 100 or the external device 200.

Then, if the user 10 inputs a control command associated with the external device 200, the electronic device 100 may activate the display and immediately display the screen 910 corresponding to the control command among the preloaded screens.

The mode switching of the electronic device 100 due to the control of the external device 200 and the operation control in the contents providing mode will be described in detail with reference to FIG. 13.

As described above, the control of the external device enables the electronic device to be activated, thereby reducing the inconvenience of the user who has to control the two devices, respectively, in that the desired screen is immediately displayed, while at the same time providing an enhanced user experience to the user.

FIG. 10 is a diagram illustrating an embodiment of setting an environment according to a reproduced content.

Referring to FIG. 10, the electronic device 100 may display a UI screen 1010 for receiving a confirmation for change in settings of the electronic device 100 and the peripheral device based on the contents of the content providing source which is executed among the preloaded content providing sources. The electronic device 100 may change settings for image quality and sound quality of the electronic device 100 based on the content being reproduced. The electronic device 100 may transmit a control command to change the setting of the IoT device connected to the electronic device 100.

For example, if the content being reproduced is an action movie, the electronic device 100 may change settings for the image quality and sound quality of the electronic device 100 to be suitable for reproducing an action movie. Although FIG. 10 illustrates that the user's confirmation is received through the UI screen 1010, but in the actual implementation, the settings may be changed without confirmation of the user.

The electronic device 100 may change the settings for the IoT device connected to the electronic device 100 to be suitable for reproducing an action movie. For example, a control command for turning off a switch of an IoT lamp, a control command for changing the mode of the peripheral IoT devices to a noise reduction mode, or a command for locking the door lock may be transmitted to each IoT device. FIG. 10 illustrates that the user's confirmation is received through the UI screen 1010, but in the actual implementation, the configuration of the peripheral IoT device may be changed without the user's confirmation.

As described above, by automatically changing setting which the user had to immediately change according to reproduced contents, convenience of a user and use experience may be improved.

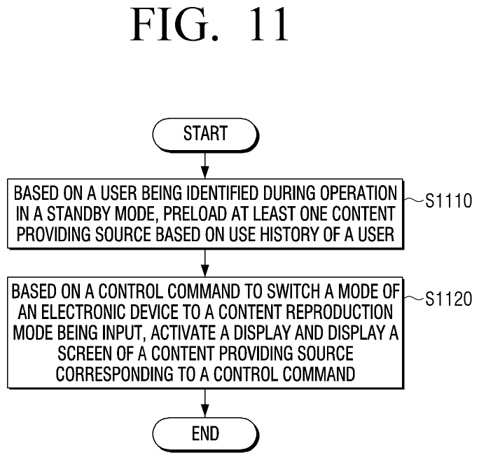

FIG. 11 is a flowchart describing a content reproduction method according to an embodiment.

Referring to FIG. 11, when a user is identified while the electronic device operates in a standby mode, the electronic device may preload at least one content providing source based on the user's use history in operation S1110.

Specifically, the electronic device may identify at least one content providing source frequently used by a user based on a use history of a user when a user is identified by using at least one of a fingerprint, a voice print, and a smartphone ID of a user.

The electronic device may preload the identified at least one content providing source. If the content providing source is provided by the electronic device, the electronic device may preload using information about the stored content providing source. The electronic device may receive information on a content providing source from an external device and preload a screen of the at least one content providing source by using the received information, if the content providing source provided by the external device is included in at least one content providing source.

When a control command for switching the mode of the electronic device to the content reproduction mode is input, the electronic device may activate the display and display a screen of the content providing source corresponding to the control command in operation S1120.

When a user presses a power button of the electronic device in a standby mode, or inputs an operation of activating a display or an execution command of a content providing source, the electronic device may activate a display and immediately display a screen corresponding to a control command of a user among screens of at least one content providing source preloaded.

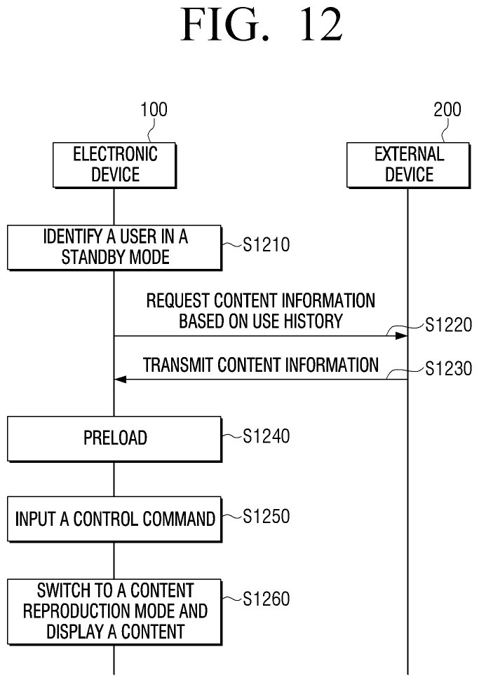

FIG. 12 is a sequence diagram illustrating a method for reproducing a content of a content providing source provided from an external device.

The electronic device 100 may identify a user in a standby mode in operation S1210. The electronic device 100 may use at least one of the user's fingerprint, voice print, and smartphone ID to identify who is the user.

The electronic device 100 may request content information to the external device 200, if the content providing source frequently used by the user is provided from the external device 200 based on the identified user's use history in operation S1220. The content information may include a home screen of an application, which is a content providing source provided by the external device 200, or content stored in the external device 200.

The external device 200 may transmit content information to the electronic device 100 according to a request for content information of the electronic device 100 in operation S1230.

The electronic device 100 may preload a screen of the content using the content information received from the external device 200 in operation S1240. In FIG. 12, although the preferred content of the user is limited to being provided by the external device 200, if the content provided from the electronic device 100 is included in at least one of content preferred by the user, the screen of the content provided by the electronic device 100 may be preloaded together. That is, a plurality of content may be preloaded based on the user's use history.

The electronic device 100 may receive a control command from a user in operation S1250. The electronic device 100 may receive a user's control command to switch from a standby mode to a content reproduction mode. In this example, the control command may be an action for pressing a power button of the electronic device 100 in the standby mode, or activating the display, or an execution command of the content providing source.

The electronic device 100 may be switched from the standby mode to the content reproduction mode and display the content in operation S1260. The electronic device 100 may activate the display and immediately display content corresponding to the user's control command among the at least one preloaded content.

FIG. 13 is a sequence diagram illustrating a method for reproducing a content through control of the external device illustrated in FIG. 9.

In a state in which the electronic device 100 is in a standby mode, the external device 200 may detect a user in operation S1310. When the external device 200 detects the movement of the remote controller dedicated to the external device 200, the external device 200 may provide the content information provided by the external device 200 to the electronic device 100 in operation S1320. The content information provided to the electronic device 100 may be a home screen provided by the external device 200, a home screen of an application that is a content providing source provided by the external device 200, or content provided by the external device 200.

The external device 200 may transmit, to the electronic device, data collected using a user's voice or a fingerprint recognition function of a remote controller together.

The electronic device 100 may preload the content based on the content information received from the external device 200 in operation S1330. The electronic device 100 may be still in a standby mode in which the display is deactivated.

The external device 200 may receive a control command from a user in operation S1340. The external device 200 may receive a control command from a user via a remote controller, such as a voice, remote controller, or a smartphone.

The external device 200 may transmit a display activation command to the electronic device 100 in operation S1350. The external device 200 may transmit a display activation command to the electronic device 100 to display content corresponding to the user's control command. In this example, the display activation command may include an execution command of the user input to the external device 200. The electronic device 100 may generate a control command to activate the display based on the content execution command. In other words, the display activation command may include a direct command or indirect command to activate the display of the electronic device 100.

The electronic device 100 may switch the mode from the standby mode to the content reproduction mode and display the content in operation S1360. The electronic device 100 may activate the display and immediately display the content of the preloaded external device 200.

Although not shown in the drawings, the electronic device 100 is switched into a content reproduction mode corresponding to a general mode through the above-described process, so that the external device 200 may be controlled by controlling the electronic device 100 as in the related art.

According to various embodiments as described above, only the desired content is displayed without the process of selecting an application or content, and the booting process according to the application execution command is omitted and thus, the use environment of the user may be improved. As an electronic device may be activated by the control of the external device, and a desired screen may be immediately displayed, a user's inconvenience to control two devices may be reduced, and an improved user experience may be provided to the user at the same time.

The various embodiments described above may be implemented in a recordable medium which is readable by computer or a device similar to computer using software, hardware, or the combination of software and hardware. By hardware implementation, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, embodiments described herein may be implemented by the processor itself. According to a software implementation, embodiments such as the procedures and functions described herein may be implemented with separate software modules. Each of the above-described software modules may perform one or more of the functions and operations described herein.

The method according to the various embodiments above may be stored in a non-transitory readable medium. The non-transitory readable medium may be stored in various apparatuses for use.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

According to embodiments, a method disclosed herein may be provided in software of a computer program product. A computer program product may be traded between a seller and a purchaser as a commodity. A computer program product may be distributed in the form of a machine readable storage medium (e.g., CD-ROM) or distributed online through an application store (e.g., PlayStore™). In the case of on-line distribution, at least a portion of the computer program product software may be stored temporarily or at least temporarily in a storage medium such as a manufacturer's server, a server in an application store, or a memory in a relay server.

The foregoing example embodiments and advantages are merely examples and are not to be construed as limiting. The present teaching can be readily applied to other types of apparatuses. Also, the description of the example embodiments is intended to be illustrative, and not to limit the scope of the claims, and many alternatives, modifications, and variations will be apparent to those skilled in the art.

What is claimed is:

1. An electronic device comprising:
a memory;
a display; and
a processor configured to:
based on a user being identified while the display is operating in a standby mode that is a deactivated state, preload at least one content providing source based on a use history of the identified user, which is stored in the memory, and
based on a control command for switching a mode of the electronic device to a content reproduction mode being input, activate the display, and control the display to display a screen of a content providing source corresponding to the control command from among the at least one content providing source.

2. The electronic device of claim 1, further comprising:
a communicator configured to communicate with an external device,
wherein the processor is further configured to:
based on a content providing source provided by the external device being included in the at least one content providing source, receive, from the external device, information on the content providing source through the communicator, and preload the content providing source provided from the external device based on the received information.

3. The electronic device of claim 1, wherein the processor is further configured to preload different content providing sources according to a time at which the user is identified.

4. The electronic device of claim 1, wherein the processor is further configured to, based on the user not being identified, preload at least one content providing source based on use history of a plurality of users stored in the memory.

5. The electronic device of claim 1, further comprising:
a communicator configured to communicate with an external device,
wherein the processor is further configured to:
based on receiving, from the external device, information on the content providing source provided by the external device through the communicator during operation in a standby mode, preload the content providing source provided by the external device based on the received information, and
based on receiving, from the external device, an activation command of the display according to a power-on command associated with the external device, control the display to display a screen of the content providing source provided by the external device.

6. The electronic device of claim 1, wherein the processor is further configured to identify the user based on at least one of an input fingerprint, an input voice print, and an input identification (ID) of a smartphone.

7. The electronic device of claim 1, wherein the control command comprises an execution command of one content providing source among the at least one content providing source.

8. The electronic device of claim 1, wherein the processor is further configured to identify the at least one content providing source to be preloaded using an artificial intelligence (AI) technology.

9. The electronic device of claim 1, wherein the processor is further configured to change setting of the electronic device based on content provided from a content providing source corresponding to the control command.

10. The electronic device of claim 1, further comprising:
a communicator configured to communicate with an Internet of Things (IoT) device,
wherein the processor is further configured to control the communicator to transmit, to the IoT device, a control command to control the IoT device based on content provided from a content providing source corresponding to the control command.

11. A method for controlling an electronic device, the method comprising:
based on a user being identified while the display is operating in a standby mode that is a deactivated state, preloading at least one content providing source based on a use history of the identified user; and
based on a control command for switching a mode of the electronic device to a content reproduction mode being input, activating the display, and displaying a screen of a content providing source corresponding to the control command from among the at least one content providing source.

12. The method of claim 11, wherein the preloading comprises, based on a content providing source provided by the external device being included in the at least one content providing source, receiving, from the external device, information on the content providing source, and preloading the content providing source provided from the external device based on the received information.

13. The method of claim 11, wherein the preloading comprises preloading different content providing sources according to a time at which the user is identified.

14. The method of claim 11, wherein the preloading comprises, based on the user not being identified, preloading at least one content providing source based on presorted use history of a plurality of users.

15. The method of claim 11, wherein the preloading comprises, based on receiving, from the external device, information on the content providing source provided by the external device during operation in a standby mode, preloading a content providing source provided by the external device based on the received information, and
based on receiving, from the external device, an activation command of the display according to a power-on command associated with the external device, displaying a screen of the content providing source provided by the external device.
